(19) United States
(12) Patent Application Publication
(10) Pub. No.: US 2009/0117516 A1
(43) Pub. Date: May 7, 2009

(54) Magnetostrictive insert element for use in a tool holder of an ultrasonic dental treatment device

(76) Inventor: Alfred Schmidt, Usingen (DE)

Correspondence Address: HOFFMAN WASSON & GITLER, P.C;CRYSTAL CENTER 2, SUITE 522, 2461 SOUTH CLARK STREET, ARLINGTON, VA, 22202-3843, US

(21) Appl. No.: 12/068,482

(22) Filed: Feb. 7, 2008

(30) Foreign Application Priority Data
Nov. 7, 2007 (DE) 10 2007 053 580.7

(51) Int. Cl. A61C 1/07

(52) U.S. Cl. 433/119

(57) ABSTRACT

The invention relates to a magnetostrictive insert element for use in a tool holder of an ultrasonic dental treatment device with at least one first longitudinal section having a dental tool and a coupling element and a second adjoining second longitudinal section with a magnetostrictive ultrasonic converter, the first longitudinal section having a first length and a first weight and the second longitudinal section having a second length and a second weight. The ratio between the first and second length is for example between 0.5 and 0.8. Alternatively or in addition, the ratio between the first and second weight is between 0.1 and 0.3.

The invention relates to a magnetostrictive insert element for use in a tool holder of an ultrasonic dental treatment.

Ultrasonic dental treatment devices are known in the art and are used to remove tartar, for example. Such devices generally feature a stationary control or drive unit and at least one tool holder, which is connected with the control or drive unit by means of a supply line.

The tool holder consists in the known manner of an elongated, hollow cylindrical housing for holding a magnetostrictive insert element. An exciter coil element is provided in the housing of the tool holder in order to drive the magnetostrictive insert element.

The insert element comprises an elongated dental tool and an adjoining rod-shaped magnetostrictive section. The dental tool is connected to the rod-shaped magnetostrictive section by means of a connecting body or a coupling element. The rod-shaped magnetostrictive section is formed for example by a plurality of elongated bars or rods made of metal, in particular of pure nickel.

The magnetostrictive insert element is inserted into the tool holder, in particular the exciter coil element, with the rod-shaped magnetostrictive section first, namely so that the rod-shaped magnetostrictive section is completed enclosed by the exciter coil element, and the coupling element and the end of the dental tool facing the coupling element are enclosed by the housing of the tool holder. The end of the dental tool facing away from the coupling element and forming the working surface of the dental tool protrudes outward.

The rod-shaped magnetostrictive section forms a magnetostrictive vibration converter, which converts an electrical signal generated by the control or drive unit and supplied to the exciter coil element via the supply line with an ultrasonic frequency into a mechanical vibration of the insert element, in particular of the dental tool.

The electrical signal is an AC signal which generates a magnetic alternating field. The magnetic alternating field causes a periodic change in the length of the rod-shaped magnetostrictive section in the form of a mechanical vibration. The generated mechanical vibrations of the rod-shaped magnetostrictive section are transmitted to the dental tool via the coupling element. For this purpose, the magnetostrictive insert element is movably mounted in the housing in the area of the coupling element.

The magnetostrictive vibration converter has a resonance frequency at which periodic vibrations with a maximum amplitude occur in the rod-shaped magnetostrictive section. The periodic vibrations occur in resonance as a standing wave and are transmitted to the dental tool, in particular its working surface or tip. To ensure that the magnetostrictive vibration converter releases the maximum possible amount of energy, it is operated in resonance.

Conventional magnetostrictive insert elements known in the art are designed to operate with one resonance frequency, for example 18, 25 or 30 kHz. Such insert elements are characterized not only by excessive weight, but also by an unmanageable length, and especially the section of the magnetostrictive insert element comprising the dental tool and the coupling element is excessively long in relation to the longitudinal extension of the rod-shaped magnetostrictive section. The relatively high weight of more than 20 grams and a total length of between 16 and 20 cm diminish the user convenience of a tool holder equipped with such an insert element.

It is an object of the invention to present an insert element for use in a tool holder of an ultrasonic dental treatment device that features improved handling properties.

### SUMMARY OF THE INVENTION

An aspect of the magnetostrictive insert element according to the invention is the fact that the ratio between the first and second length of the first and second longitudinal sections is between 0.5 and 0.8.

A further aspect of the magnetostrictive insert element according to the invention is the fact that the ratio between the first and second weight of the first and second longitudinal sections is between 0.1 and 0.3.

Therefore, a special advantage of the magnetostrictive insert element is that it is considerably smaller and lighter than the magnetostrictive insert elements known in the art, without this affecting the power output. A toolholder of an ultrasonic dental treatment device equipped with the magnetostrictive insert element according to the invention is considerably more user-friendly and less tiring to use. A further advantage is that the magnetostrictive insert element according to the invention can be used with older ultrasonic dental treatment devices already installed in dentist's offices.

A further advantage is that the magnetostrictive insert element has a total length of between 90 mm and 130 mm, preferably 110 mm and a total weight of less than 17 grams, preferably between 13 grams and 15 grams.

### BRIEF DESCRIPTION OF THE DRAWINGS

The invention is described in more detail below based on an exemplary embodiment as referred to in the drawings, wherein:

FIG. 1 exemplifies an ultrasonic dental treatment device and

FIG. 2 exemplifies a side view of the magnetostrictive insert element according to the invention for use in the tool holder of the ultrasonic dental treatment device of FIG. 1.

### DETAILED DESCRIPTION OF THE INVENTION

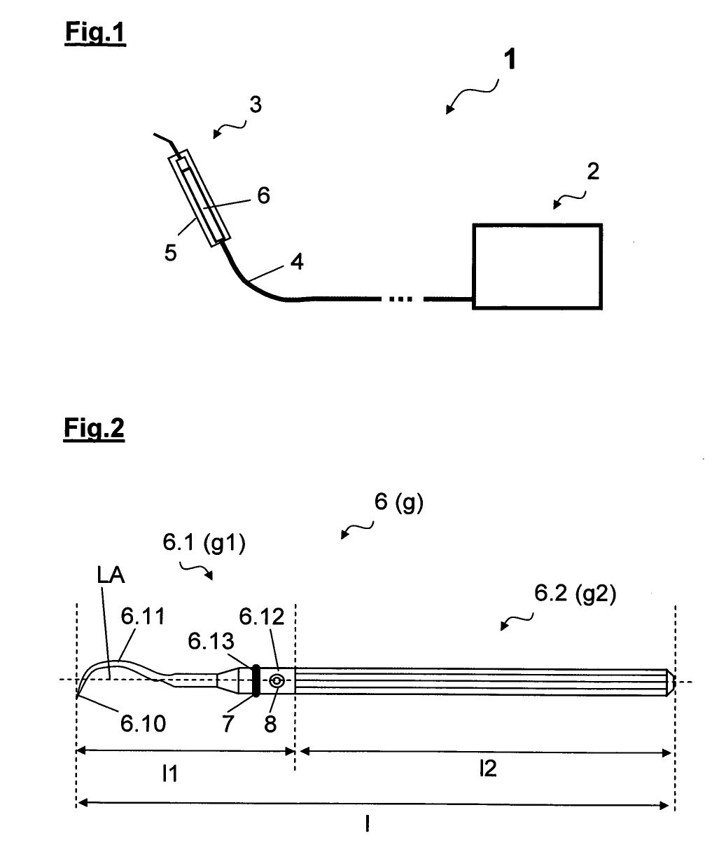

FIG. 1 is a schematic diagram representing an ultrasonic dental treatment device 1, which is used for dental hygiene, in particular for treating tartar and/or plaque. The design and operation of such ultrasonic dental treatment devices 1 are familiar from the known art.

The ultrasonic dental treatment device 1 consists for example of a control or drive unit 2 and a tool holder 3, which is connected to the control or drive unit 2 by means of at least one supply line 4.

The tool holder 3 comprises an elongated, preferably hollow cylindrical housing 5, which is made of plastic, for example. The housing 5 of the tool holder 3 is designed for at least sectionwise holding of an elongated magnetostrictive insert element 6.

FIG. 2 shows a schematic side view of such a magnetostrictive insert element 6, which is operated for example at a resonance frequency of ca. 30 kHz.

The magnetostrictive insert element 6 comprises at least one first longitudinal section 6.1 and one adjoining second longitudinal section 6.2, the two sections being arranged successively along the longitudinal axis LA of the magnetostrictive insert element 6 and therefore forming an elongated structure.

The first longitudinal section 6.1 comprises a dental tool 6.11, to which a coupling element 6.12, which for example has a hollow cylindrical form, is connected in the direction of the second longitudinal section 6.2 along the longitudinal axis LA. The coupling element 6.12 graduates into the dental tool 6.11, which comprises a working surface or tip 6.10 for dental treatment, in particular for removal of tartar and/or plaque.

Further, the coupling element 6.12 features a groove 6.13 extending concentrically to the longitudinal, axis LA, in which (groove) a rubber ring 8 is held, so that said ring protrudes outward at least partially from the outer surface of the coupling element 6.12. The rubber ring 7 is used for the movable mounting of the magnetostrictive insert element 6 in the housing 5 of the tool holder 3, so that the magnetostrictive insert element 6 can freely vibrate along the longitudinal axis LA of the housing 5.

Adjacent to the rubber ring 7 an opening 8 is provided in the coupling element 6.12, via which (opening) a fluid can be supplied, for example in a fluid channel provided in the dental tool 6.11. The fluid is supplied for example by the control or drive unit 2 via the supply line 4.

The second longitudinal section 6.2 adjoining the coupling element 6.12 of the first longitudinal section 6.1 forms a magnetostrictive ultrasonic converter, which for example is formed by a packet made up of a plurality of elongated bars or rods made of metal, in particular of pure nickel.

The ends of the bars or rods facing toward the coupling element 6.12 are preferably held by the hollow cylindrical coupling element 6.12 and are therefore rigidly connected with said coupling element. The ends of the bars or rods facing away from the coupling element 6.12 are preferably rigidly connected with each other, in particular by soldering.

The magnetostrictive insert element 6 according to the invention has a total length I of between 90 mm and 130 mm, preferably 110 mm, and the first longitudinal section 6.1 has a first length I1 between 30 mm and 50 mm, preferably 40 mm and the second longitudinal section 6.2 has a second length I2 between 60 mm and 80 mm, preferably 70 mm. The ratio of the first and second length I1, I2 of the first and second longitudinal section 6.1, 6.2 is therefore between 0.5 and 0.8, preferably between 0.55 and 0.6.

Therefore, especially the first longitudinal section 6.1 of the magnetostrictive insert element 6 according to the invention is considerably shorter than magnetostrictive insert elements known in the art (ca. >80 mm), resulting in significantly better handling.

Alternatively or in addition, the magnetostrictive insert element 6 according to the invention has a total weight g of less than 17 grams, preferably between 13 grams and 15 grams, and the first longitudinal section 6.1 has a first weight g1 and the second longitudinal section 6.2 has a second weight g2.

The first weight g1 of the first longitudinal section 6.1 is for example between 1.5 grams and 3 grams, preferably between 2 grams and 2.5 grams and the second weight g2 of the second longitudinal section 6.2 is between 10.5 grams and 13 grams, preferably between 11 grams and 12 grams. The ratio of the first and second weight g1, g2 of the first and second longitudinal section 6.1, 6.2 is therefore between 0.1 and 0.3, preferably between 0.15 and 0.25.

The invention was described above based on an exemplary embodiment. It goes without saying that numerous modifications and variations are possible without abandoning the underlying inventive idea on which the invention is based.

### REFERENCE LIST

1 ultrasonic dental treatment device

2 control or drive unit

3 tool holder

4 supply line

5 housing

6 magnetostrictive insert element

6.1 first longitudinal section

6.10 working surface or working tip

6.11 dental tool

6.12 coupling element

6.13 groove

6.2 second longitudinal section or magnetostrictive ultrasonic converter

7 rubber ring

8 opening

LA longitudinal axis

I total length

I1 first length

I2 second length

g total weight

g1 first weight

g2 second weight

What is claimed is:

1. A magnetostrictive insert element for use in a tool holder of an ultrasonic dental treatment device with at least one first longitudinal section comprising a dental tool and a coupling element and a second adjoining second longitudinal section comprising a magnetostrictive ultrasonic converter, the first longitudinal section having a first length and the second longitudinal section having a second length, wherein a the ratio of the first and second length of the first and second longitudinal section is between 0.5 and 0.8.

2. The magnetostrictive insert element according to claim 1, wherein the first longitudinal section has a first weight (g1) and the second longitudinal section has a second weight (g2) and the ratio between the first and second weight (g1, g2) of the first and second longitudinal section is between 0.1 and 0.2.

3. A magnetostrictive insert element for use in a tool holder of an ultrasonic dental treatment device with at least one first longitudinal section comprising a dental tool and a coupling element and a second adjoining second longitudinal section comprising a magnetostrictive ultrasonic converter, the first longitudinal section having a first weight (g1) and the second longitudinal section having a second weight (g2), wherein the ratio of the first and second weight (g1, g2) of the first and second longitudinal section is between 0.1 and 0.3.

4. The magnetostrictive insert element according to claim 3, wherein the first longitudinal section has a first length and the second longitudinal section has a second length and the ratio between the first and second length of the first and second longitudinal section is between 0.5 and 0.8.

5. The magnetostrictive insert element according to claim 3, wherein a total length of the element is between 90 mm and 130 mm, preferably 110 mm.

6. The magnetostrictive insert element according to claim 3, wherein a total weight (g) of the element is less than 17 grams.

7. The magnetostrictive insert element according to claim 3, wherein a total weight (g) of the element is between 13 grams and 17 grams.

8. The magnetostrictive insert element according to claim 4, wherein the first length is between 30 mm and 50 mm.

9. The magnetostrictive insert element according to claim 4, wherein the second length is between 60 mm and 80 mm.

10. The magnetostrictive insert element according to claim 3, wherein the first weight is between 1.5 grams and 3 grams.

11. The magnetostrictive insert element according to claim 3, wherein the second weight is between 10.5 grams and 13 grams.
